(19) United States
(12) Patent Application Publication
(10) Pub. No.: US 2016/0372998 A1
(43) Pub. Date: Dec. 22, 2016

(54) Vibration Motor

(71) Applicants: HONGFU XU, SHENZHEN (CN); ZHILIN CHAI, SHENZHEN (CN); NA WU, SHENZHEN (CN)

(72) Inventors: HONGFU XU, SHENZHEN (CN); ZHILIN CHAI, SHENZHEN (CN); NA WU, SHENZHEN (CN)

(73) Assignee: AAC TECHNOLOGIES PTE. LTD., SINGAPORE CITY (SG)

(21) Appl. No.: 15/005,074

(22) Filed: Jan. 25, 2016

(30) Foreign Application Priority Data
Jun. 16, 2015 (CN) 201520414805.0

(51) Int. Cl. H02K 33/02; F16F 13/04

(52) U.S. Cl. CPC H02K 33/02; F16F 13/04

(57) ABSTRACT

A vibration motor is disclosed. The vibration motor includes a housing; a vibrator placed in the housing; and a flat leaf spring for elastically supporting the vibrator in the housing. The flat leaf spring includes an elastic body and damping material placed in the elastic body.

### FIELD OF THE INVENTION

The present disclosure is related to motors, specifically to a vibration motor equipped with a flat leaf spring.

### DESCRIPTION OF RELATED ART

A vibration motor refers to a component which converts electric energy to mechanical energy by means of an electromagnetic force generation principle; the vibration motor is generally installed in a portable phone and so on to generate silent receipt signals so as to avoid the inconvenience caused to other people due to external sound. The vibration motor mainly includes rotary vibration motor type and linear vibration motor type, wherein when using the rotary vibration motor, a rotor unbalanced in weight rotates to generate mechanical vibration. And in addition, when using the linear vibration motor, the motor is vibrated by electromagnetic force and driven linearly so as to generate mechanical vibration, and the electromagnetic force has resonant frequency confirmed by a spring and a vibrator suspended on the spring.

As shown in FIG. 1, the Chinese patent application No.: 201320780850.9 discloses a spring 8′ used for a linear vibration motor. The spring 8′ comprises a first connecting part 81′ connected with a vibration block, a second connecting part 82′ connected with a housing and an intermediate connecting part 83′ connecting the first connecting part 81′ with the second connecting part 82′, the first connecting part 81′, second connecting part 82′ and intermediate connecting part 83′ form an open slot 84′, wherein the first connecting part 81′ is connected with the intermediate connecting part by a first transition circular arc 85′, and the second connecting part 82′ is connected with the intermediate connecting part by a second transition circular arc 86′. When the motor vibrates, the spring provides the vibration block with restoring force, the amplitude of the vibration block is influenced due to the resistance influence, this will seriously influence the amplitude effect of a magnetic path system in the housing and further influence the frequency bandwidth to lead to a low product reliability, and therefore, it is necessary to research a vibration motor with a novel flat leaf spring.

Therefore, it is necessary to provide a new linear vibration motor to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a flat leaf spring disclosed by the related technology.

FIG. 2 is an isometric view of a vibration motor in accordance with an exemplary embodiment of the present disclosure.

FIG. 3 is a top view of components of the vibration motor in FIG. 2.

FIG. 4 is an isomeric view of a flat leaf spring of the vibration motor.

FIG. 5 is an isometric view of a flat leaf spring of a second embodiment of the present disclosure.

FIG. 6 is an illustration of a flat leaf spring of a third embodiment of the present disclosure.

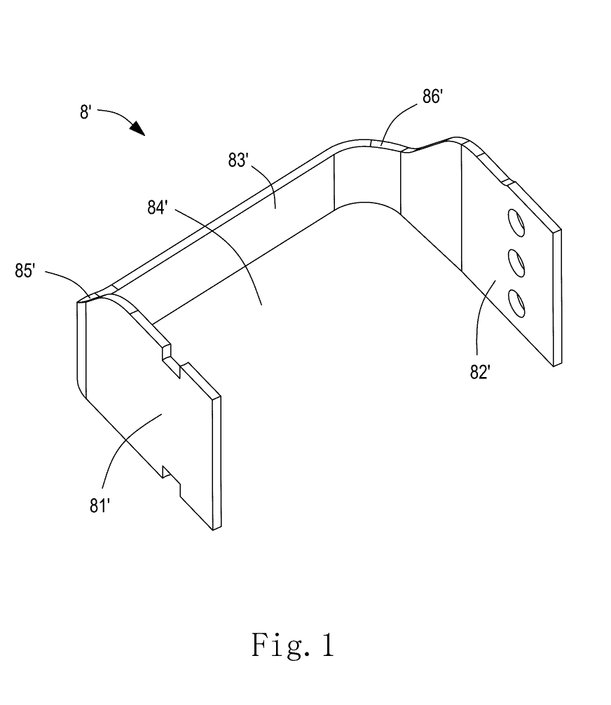

### DETAILED DESCRIPTION OF THE EXEMPLARY EMBODIMENTS

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

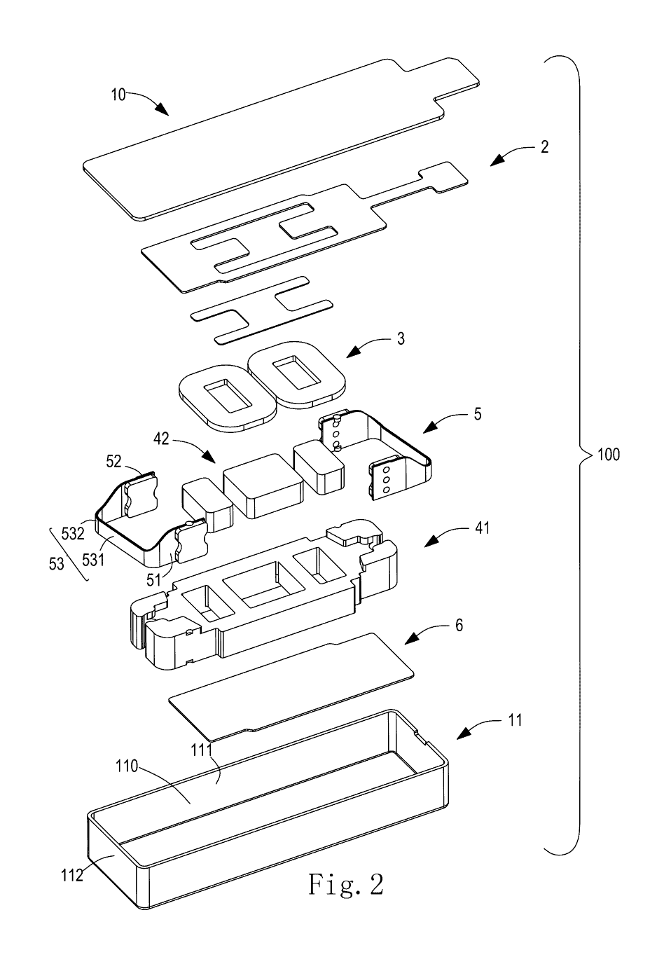

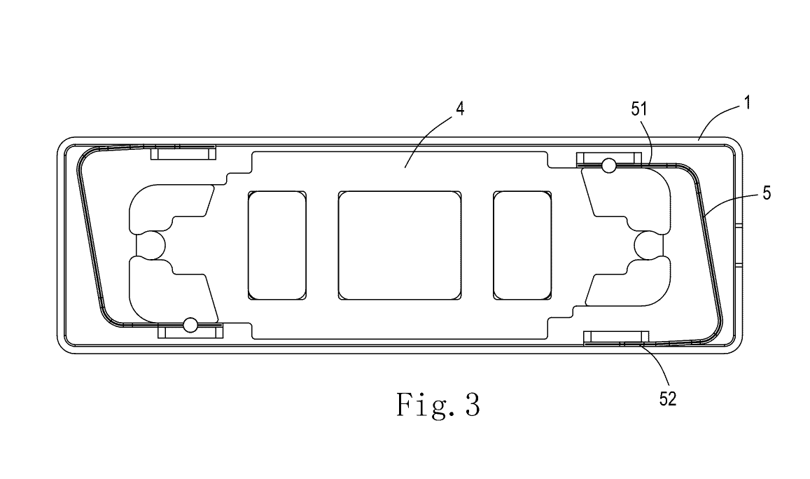

As shown in FIGS. 2-3, a vibration motor 100 includes a housing 1 equipped with a holding space 110, a vibrator 4 placed in the holding space 110, a coil 3, a circuit board 2 and a flat leaf spring 5 for supporting the vibrator 4 on the housing 1. The housing comprises an outer housing 11 and a cover plate 10 which covers the outer housing 11, and the outer housing 11 includes a first side wall 111 parallel to a vibration direction of the vibration motor 100 and a second side wall 112 vertical to the vibration direction of the vibration motor 100. The coil 3 and the circuit board 2 arranged on the cover plate 10 are connected with an external circuit (not shown) to realize electrical signal input.

The vibrator 4 is placed in the holding space 110 of the housing 1 and includes a mass block 41 and permanent magnets 42. A plurality of cavities is formed in the mass block 41, and the permanent magnet 42 is arranged in each cavity. The vibration motor 100 is further provided with a pole piece 6 attached to the mass block 41. The mass block 41 is suspended and propped in the holding space 110 by the flat leaf spring 5, and the permanent magnets 42 are opposite to the coil 3 and spaced from the same.

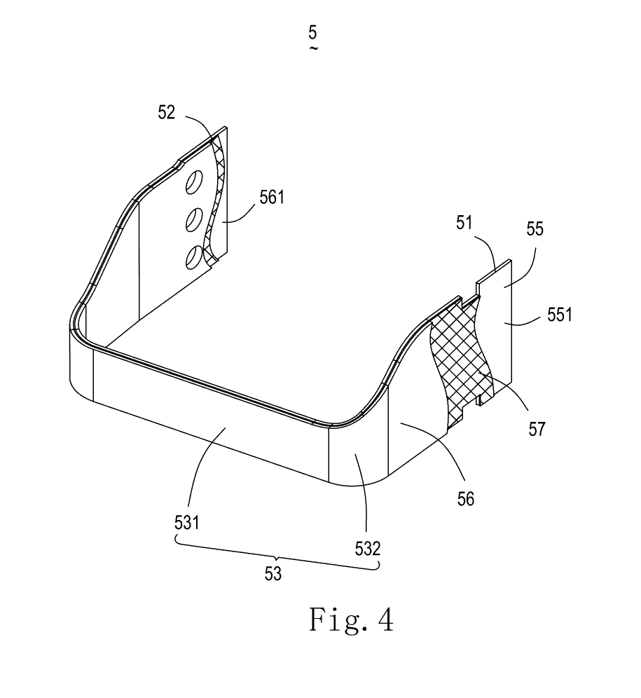

As shown in FIG. 4, the flat leaf spring 5 includes a first locating part 51 connected with the mass block 41, a second locating part 52 connected with the first side wall 111 of the outer housing 11 and an elastic part 53 connecting the first locating part 51 with the second locating part 52, wherein the elastic part 53 includes a slab part 531 and a bend part 532.

As shown in FIG. 4, a flat leaf spring 5 comprises a plurality of elastic pieces, and damping material arranged between two adjacent elastic pieces. When two elastic pieces are used, the two elastic pieces are defined as a first elastic piece 55 and a second elastic piece 56 covering the first elastic piece 55. The first elastic piece 55 is the same with the second elastic piece 56 in shape, and it can be interpreted as that the flat leaf spring 5 includes two elastic pieces overlapping each other. The surface on the first elastic piece 55 fitting the second elastic piece 56 is defined as a first fitting surface 551, the surface on the second elastic piece 56 fitting the first elastic piece 55 is defined as a second fitting surface 561, wherein damping material 57 is arranged between the first fitting surface 551 and second fitting surface 561. The damping material 57 can be glue, foam, double faced adhesive tape, silica gel and so on.

As shown in FIG. 5, a flat leaf spring 5′ is a hollow elastic bracket 55′, and damping material 57′ is filled in the hollow of the elastic bracket 55′. The damping material 57′ can be glue, foam, double faced adhesive tape, silica gel and so on. The elastic bracket 55′ includes a first locating part 51′ connected with a mass block 41 and a second locating part 52′ connected with the first side wall 111 of an outer housing 11, the elastic part 53′ is set as hollow, the damping material 57′ is filled in the hollow of the elastic part 53′, wherein the elastic part 53′ includes a slab part 531′ and a bend part 532′.

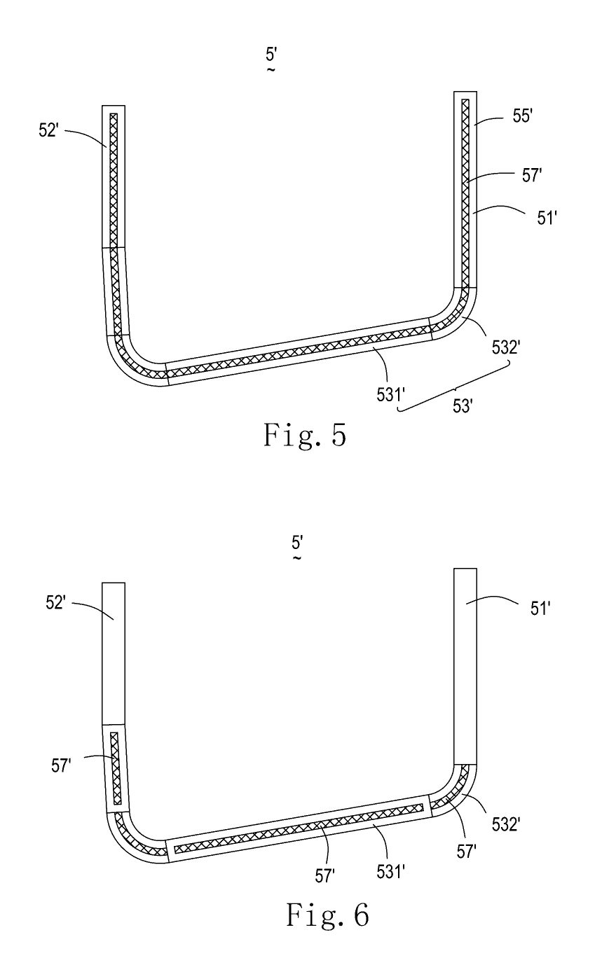

As shown in FIG. 6 6, a flat leaf spring 5′ is a hollow elastic bracket 55′ including a first locating part 51′ connected with a mass block 41 and a second locating part 52′ connected with the first side wall 11 of an outer housing 11. The elastic part 53′ is set as hollow, and damping material 57′ is filled in the hollow of the elastic part 53′. The damping material 57′ can be glue, foam, double faced adhesive tape, silica gel and so on. Wherein the elastic part 53′ includes a slab part 531′ and a bend part 532′ which are set as hollow, and the damping material 57′ is filled in the hollows of the bend part 532′ and slab part 531′. It can be interpreted as that the part bearing great stress of the elastic bracket 55′ of the flat leaf spring 5′ is set as hollow, and the damping material 57′ is filled in the hollow of the part.

When the vibration motor 100 works, the coil 3 located above the permanent magnet 42 is electrified through the circuit board 2 so as to generate a magnetic field to concentrate force on the permanent magnet 42. Because the current direction is changed along with time, the forced direction of the permanent magnet is also changed, and the vibrator 4 reciprocates by the support of the flat leaf spring 5. Because the vibrator 4 needs high-frequency reciprocating motion, the damping plays an important role when the flat leaf spring 5 provides elastic force, and the material for increasing the mechanical damping is added to the flat leaf spring 5 to improve the frequency bandwidth of the vibrator 4.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vibration motor including:
a housing;
a vibrator placed in the housing;
and a flat leaf spring for elastically supporting the vibrator in the housing; wherein
the flat leaf spring includes an elastic body and damping material placed in the elastic body.

2. The vibration motor according to claim 1, wherein the elastic body comprises a first elastic body and a second elastic body corresponding to the first elastic body, and the damping material is sandwiched between the first elastic body and second elastic body.

3. The vibration motor according to claim 1, wherein the elastic body is hollow, and the damping material is filled in the elastic body.

4. The vibration motor according to claim 1, wherein the flat leaf spring includes a first locating part connected and fixed with the vibrator, a second locating part connected with the housing, and an elastic part connecting the first locating part with the second locating part.

5. The vibration motor according to claim 4, wherein the elastic part includes a slab part and an elastic bend part connected with the slab part.

6. The vibration motor according to claim 5, wherein the damping material is arranged at the bend part.

7. The vibration motor according to claim 1, wherein the damping material is glue, foam, double faced adhesive tape or silica gel.
